(19) United States
(12) Patent Application Publication
(10) Pub. No.: US 2025/0177938 A1
(43) Pub. Date: Jun. 5, 2025

(54) DEVICE AND METHOD FOR MIXING COMPONENTS OF A CERAMIC STARTING MATERIAL

(71) Applicant: bredent GmbH & Co. KG, Senden (DE)

(72) Inventor: Joachim MEYER, Heimertingen (DE)

(73) Assignee: bredent GmbH & Co. KG, Senden (DE)

(21) Appl. No.: 18/841,069

(22) PCT Filed: Feb. 27, 2023
(86) PCT No.: PCT/EP2023/054863

§ 371 Date: Aug. 23, 2024

(30) Foreign Application Priority Data
Feb. 28, 2022 (DE) 10 2022 104 741.5

(51) Int. Cl. B01F 35/82; B01F 23/60; B01F 35/00; B01F 35/21; B01F 35/221; B01F 35/75; B01F 101/19

(52) U.S. Cl. CPC B01F 35/82; B01F 23/60; B01F 35/2117; B01F 35/2218; B01F 35/75415; B01F 35/79; B01F 2101/19

(57) ABSTRACT

In a device and a method for mixing components of a ceramic starting material, a flowable powdered ceramic material as a first component can be supplied via a first inlet opening and a flowable powdered additive as a second component can be supplied via at least one further inlet opening, each in a meterable manner, to a mixing system in such a way that the first component and the second component mix homogeneously in the mixing system to form a mixed material variably enriched with the additive, which can be supplied as a ceramic starting material for further processing.

The invention relates to an apparatus and a method for mixing ingredients of a ceramic starting substance.

DE 21 31 600 A discloses an apparatus for the manufacture of a mixture of products having the consistency of grain, powder or meal.

The publication DE 696 21 627 T2 discloses a system for mixing thermoplastic polymer pellets.

EP 3 770 563 A1 discloses a system for weighing and mixing ingredients for the manufacture of asphalt.

From the general prior art, it is known how to obtain specific physical or chemical properties in ceramic materials by means of appropriate process management or specific choice of the starting substances. As a distinction from ceramics used merely decoratively, such ceramic materials are referred to as technical ceramics. A subgroup in this respect is formed by ceramic materials for medical-related applications, which are supposed to have a biocompatibility suitable for the use in human or animal bodies and frequently also a high strength. Examples in this regard are dental ceramics, which as dentures in the form of a single-tooth restoration or a partial or complete prosthesis are usually fixed on implants inserted in a jawbone. A particularly suitable ceramic material for this purpose is zirconium dioxide.

For the manufacture of dental-ceramic workpieces, such as, for example, dental crowns or dental prostheses, different methods are known from the prior art. This includes, for example, the machining of a green ceramic, which has been described in WO 2017/202869 A1 among other sources. In this case, a green compact from a mixture comprising a ceramic powder and a binder system is used. From the green compact, it is possible to manufacture a ceramic shell for dentures, wherein the ceramic shell can be shaped and adapted to a wearer prior to a baking step below a temperature of 1,050° C.

In WO 2018/050811 A1, an apparatus for functionalization for dental applications is described together with a method for the purpose, wherein an applicator device comprises a support for receiving a partly machined dental molding for the manufacture of a dental restoration and a delivery device for infiltration of a functionalization material onto at least portions of the surface of the dental molding.

The fabrication of dentures in this context frequently takes place by means of so-called milling discs which, however, often have to be designed with a color gradient for simulation of natural teeth. For the use of a semifinished product (milling blank), different manufacturing techniques are possible in this connection. Thus a pre-pressing may be performed on different color or material zones, which after that are joined one above the other in a manner adapted to the color gradient and then pressed once again. Similarly, it is possible to use a multi-layer pressing technique, in which the color or material zones following one another correspondingly are joined in pre-mixed manner. The mixtures are then transferred one after the other into a press mold, wherein a pressing of the granulates shaken onto one another then takes place. In addition, a pre-compaction may be performed here, in order to make a color transition more appealing.

Starting from this prior art, the task is now posed of creating an apparatus and a method for mixing ingredients of a ceramic starting substance that permit a high production throughput and simultaneously enable a cost-effective fabrication.

This task is accomplished by the features of the independent claims 1 and 13. Further advantageous configurations of the invention are respectively subject matter of the dependent claims. These may be combined with one another in technologically practical ways. The description, especially in connection with the drawing, additionally characterizes and specifies the invention.

According to the invention, an apparatus for mixing ingredients of a ceramic starting substance are specified, wherein, via a first inlet opening, a free-flowing, powdery ceramic material as first ingredient and, via at least one further inlet opening, a free-flowing powdery additive as second ingredient can be fed respectively in metered manner to a mixing system, so that the first ingredient and the second ingredient become mixed homogeneously in the mixing system to a mixture, which is enriched variably with the additive and can be fed as ceramic starting substance to a further processing.

Accordingly, the mix as ceramic starting substance for the further processing is generated by the apparatus according to the invention, so that on the one hand it is mixed homogeneously but on the other hand may also be enriched variably with respect to the additive. In this way it is possible, by virtue of the meterability during the feeding to the mixing system via the inlet openings, to achieve a desired composition of the mix. Different procedures are conceivable here for the variable enrichment with the additive. Besides a graded process management during the change of the admixing of the additive, it is possible in general to achieve a feeding of the needed quantity of additive in specifically volume-defined manner, so that material properties of the ceramic material are possible that cannot be achieved by the layer-pressing known from the prior art. By virtue of the meterability of the feeding of the ingredients, ceramic starting material for the further processing can be produced reproducibly.

According to one embodiment of the invention, the ceramic starting substance may be further processed to a technical ceramic.

In general, the apparatus according to the invention is suitable for all free-flowing ceramic materials in powder form. However, the specific influencing of physical or chemical properties of the ceramic material via the admixtures of additives proves to be particularly advantageous for technical ceramics. At this place, it should be mentioned that typically several additives are admixed in order to achieve the desired properties. As regards the type, the number and the quantity of the additives, no kind of restrictions are provided in the apparatus according to the invention.

According to a further embodiment of the invention, the ceramic starting substance may be further processed to a medical, especially a dental ceramic, wherein the first ingredient is preferably a ready-to-press granulate in the form of an RTP granulate of ZrO₂.

It is particularly advantageous to use the apparatus according to the invention for the manufacture of dental products. What is intended here is in particular the use during the manufacture of a semifinished product, also known as milling blank, in which, starting from a ready-to-press granulated material of zirconium dioxide, an admixture of additives for specific change of the color, for example, can be carried out in order to be able to create a denture of adapted color. This is generated in technically conventional manner from the semifinished product by milling. Such a product may be not only a dental crown but also a dental prosthesis.

According to one embodiment of the invention, the first and/or the further ingredient can be fed in controlled manner to the mixing system via a metering unit. In the process, the metering units can be controlled via a control system during the feeding to the mixing system.

As was already mentioned above, the meterability during the feeding of the first ingredient and of the second ingredient is an important aspect of the reproducible generation of the mix as ceramic starting substance for the further processing. For this purpose it is possible, according to this embodiment, to use one or respectively one metering unit for the addition of the ingredients, the delivery of which can be controlled in suitable manner. One possible configuration of a meterability may be a screw conveyor, wherein the quantity actually fed to the mixing system can be deduced from a conveying value of the screw conveyor that can be calculated from the geometry of the screw conveyor, the bulk density, the rpm and the duration of the feeding. Due to the coupling of the metering unit or of the metering units with the control unit, a correspondingly controlled delivery of the ingredients is made possible.

According to one embodiment of the invention, the metering unit is equipped with a measuring unit for monitoring the fed quantity. This measuring unit may be coupled with the control unit.

In this way, the concept of the controlled feeding described above is expanded to the effect that the quantity actually fed is monitored by a measuring unit. Thus it is possible to detect any deviations that may exist in the bulk density, for example due to inhomogeneities, agglomerates or an uneven distribution in the department was during the ongoing process and to compensate for them dynamically by the control unit via adaptation of the metering speed. Besides a screw conveyor, it would also be possible to use a piston-type conveyor or a vibratory conveyor. Other suitable conveyor units are obviously not ruled out.

According to one embodiment of the invention, the mixing system is equipped with a downspout.

A downspout represents one possible configuration of the mixing system, wherein a configuration is provided here that resembles a static mixer. This involves a free-fall mixing process, which makes it possible to expect a mixing quality adequate for implementation of the invention.

According to one embodiment of the invention, the mixing system is equipped with physical, static, or dynamic mixing elements, or it generates an air swirl by means of air pressure or one performs air mixing combined with an air extraction process.

In order to achieve the homogeneous distribution of the different ingredients in the mix, it is possible to provide additional mixing elements capable of further improving the mixing quality. For this purpose, it is possible to use different mixed media, wherein the choice of the mixed media can be determined in simple manner by experiments.

According to one embodiment of the invention, a mixing bar, a shaker plate, a sieve or an air-swirling system is provided on the downspout for mixing.

Such devices permit an improvement of the mixing quality and may be used as needed in the apparatus according to the invention.

According to one embodiment of the invention, the downspout is climate-controlled and/or equipped with a vibratory unit.

Whereas a climate-control system prevents condensation and formation of agglomerate in the mix, a vibratory unit ensures a uniform density of the mix after exiting from the mixing system. According to one embodiment of the invention, the mix can be fed to a weighing scale after exiting from the mixing system.

Besides the above-described check of the actual addition of the ingredients on the inlet side by means of the measuring unit, it is similarly possible to weigh the mix on the outlet side upon exiting from the mixing system, in order to achieve a balance in relation to the process time. Thus an input of differently metered quantities during the time-delayed passage through the mixing system can be detected by means of the weighing scale and relayed to the control unit.

Furthermore, according to the invention, a method is specified for mixing ingredients of a ceramic starting substance, especially by means of an apparatus such as described above, in which the following steps are executed: provision of a mixing system, metered feeding of a first ingredient as free-flowing powdery ceramic material and of a second ingredient as additive, mixing of the first ingredient and of the second ingredient in the mixing system, so that the first ingredient and the second ingredient become mixed homogeneously in the mixing system to form a mixture, which is enriched variably with the additive, and further processing of the mix as ceramic starting substance.

According to one embodiment of the method according to the invention, the metered feeding is performed by means of metering units, wherein the metering units are controlled dynamically during the filling with respect to a throughput of the first ingredient or of the second ingredient.

According to a further embodiment of the method according to the invention, the metering units are equipped at the outlet with measuring units, which monitor the quantity actually fed by the metering units.

According to a further embodiment of the method according to the invention, the mix is fed to a weighing scale after exiting from the mixing system.

According to a further embodiment of the method according to the invention, a control unit controls the metering units on the basis of the values of the weighing scale.

According to a further embodiment of the method according to the invention, a control unit controls the metering units on the basis of the values of the weighing scale and of the measuring units.

The invention will be explained in more detail in the following with reference to the drawing, wherein:

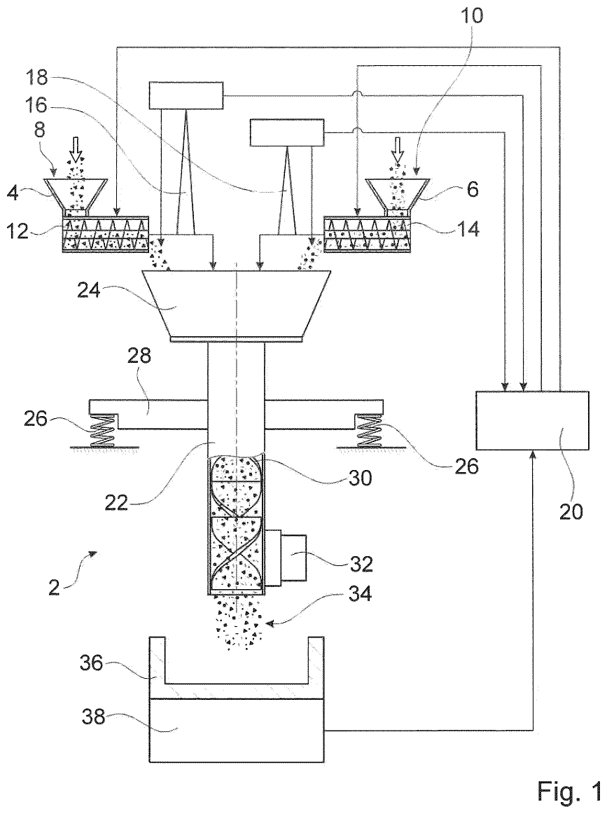

FIG. 1 shows a schematic representation of an apparatus according to the invention,

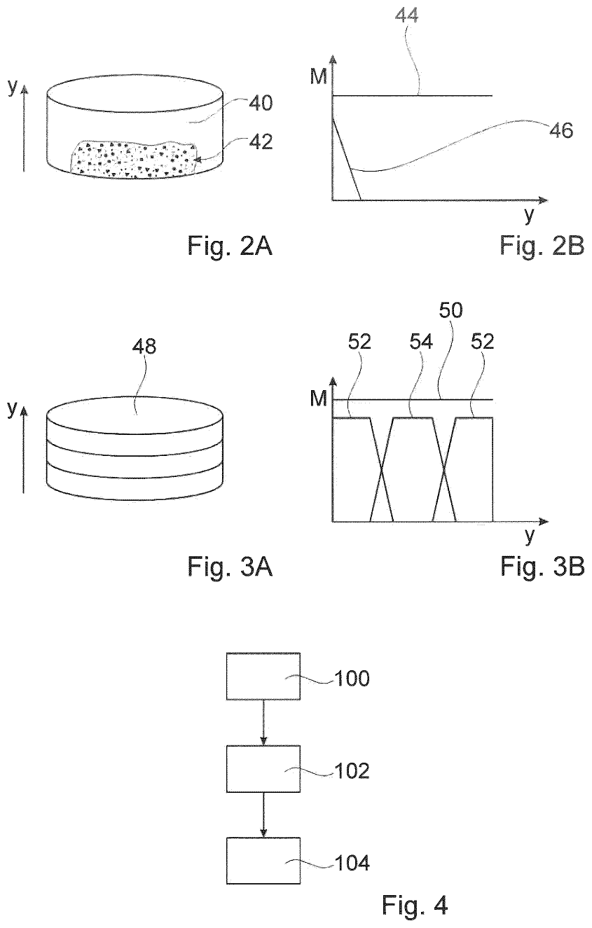

FIGS. 2A and 2B show a first example of a ceramic component part manufactured with the apparatus from FIG. 1 together with a density distribution of the ingredients,

FIGS. 3A and 3B show a second example of a ceramic component part manufactured with the apparatus from FIG. 1 together with a density distribution of the ingredients, and

FIG. 4 shows a method according to the invention in a flow diagram.

In the figures, like or like-acting elements are denoted by the same reference symbols.

In the following, an embodiment of an apparatus 2 according to the invention for mixing ingredients of a ceramic starting substance is described with reference to FIG. 1. The apparatus 2 is shown in FIG. 1 in a schematic view, wherein only the components relevant for the invention are illustrated. In this way, the invention will be explained by way of example on the basis of the mixing of a ceramic material with an additive. It goes without saying, however, that the invention may be expanded to further addition of additional additives. In practice, it is to be assumed that the apparatus 2 typically processes five additives as admixtures.

In FIG. 1, it is apparent that the apparatus 2 has, for each of the two substances, a filling funnel 4, 6, which is equipped with a corresponding inlet opening 8, 10 for addition of the ceramic material as first ingredient and of the additive as second ingredient. Via the first inlet opening 8, free-flowing powdery ceramic material is added as granulate. This may be in particular ready-to-press granulate, which is also known as RTP granulate, comprising zirconium dioxide. The second inlet opening 10 may be used, for example, for the feeding of a dye as additive for the ceramic granulate. In other embodiments, the additive may be considered for the specific influencing of the physical or chemical properties of the ceramic granulate.

Respectively one metering unit 12, 14, which in the shown exemplary embodiment may be designed as a screw conveyor, is connected to the two filling funnels 4, 6. The metering units 12, 14 respectively ensure the controlled addition of a predetermined quantity of the respective substance. Thus it is possible, for example on the basis of the duration of activation of the metering units 12, 14, to determine the delivered quantity on the basis of the intrinsic parameters, i.e. the screw geometry, bulk density and rpm of the metering units 12, 14.

Optionally, one metering unit 12, 14 is, or else, as shown, both are equipped with a measuring unit 16, 18. Via the measuring units 16, 18, a balance of the quantity actually delivered by the metering units 12, 14 can be obtained. Both the metering units 12, 14 and the measuring units 16, 18 if present are connected with a control unit 20, which controls the delivery of the substances via the metering units 12, 14 and if necessary incorporates the values of the measuring units 16, 18 into the control system.

The substances delivered by the metering units 12, 14 now pass into the actual mixing system 22 which, as illustrated in FIG. 1, is designed in the form of a downspout, which at its upper end has a feeder 24 for receiving the substances delivered by the metering units 12, 14.

The mixing system 22 is fixed in a manner vibration-damped by springs 26 in a holder 28. The mixing system 22 may have further mixing elements 30, which additionally improve the quality of mixing of the two substances. For this purpose, the mixing system 22 may be equipped with physical, static, or dynamic mixing elements 30, or it may generate an air swirl by means of air pressure or it may perform an air mixing combined with an air extraction process. Further components, such as, for example, a mixing bar, a shaker plate, a sieve or an air-swirling system may likewise be provided if necessary.

The mixing system 22 may be equipped in the region of the downspout with a vibrator 32, which most largely prevents the formation of clumps in the mix. The mix 34 exits the mixing system 22 and is fed to a mold 36, which may be disposed on a weighing scale 38, which may likewise exchange signals with the control unit 20. Instead of the mold 36, however, a casting shoe may also be used. The region of the downspout in the mixing system 22 may be climate-conditioned.

The mix 34 fed to the mold 36 can be controlled over wide ranges with respect to its composition via the controlled addition of the substances to be mixed, so that reproducible starting substances can be created for further processing.

In FIG. 2A, the use of the apparatus 2 is explained once again on the example of a manufacture of a milling blank. After a pressing of the mix 34 present in the mold 36, the graduated addition of a dye as additive via the second inlet opening 10 to the RIP granulate of zirconium dioxide fed via the first inlet opening 8 yields a semifinished product 40, which has a color-adapted gradient 42, and from which a dental crown or a dental prosthesis can be fabricated by chip-removing machining.

The color-adapted gradient 42 from FIG. 2A is shown once again in FIG. 2B on the basis of the fed quantities M of the two substances. It is evident that the fed granulate of zirconium dioxide according to curve 44 remains substantially constant, while the additive as the color addition increases gradually according to curve 46.

A further use of the apparatus 2 is shown in FIG. 3A. Instead of a homogeneously graded admixing of a dye, several layers are generated here during the manufacture of a component part 48 having different additives, in order, for example, to attain different mechanical properties. According to FIG. 3B, the quantity M of the addition of the plastic granulate in this process follows a curve 50, the addition of the first or second additive a curve 52 or 54.

A corresponding method according to the invention is illustrated once again on the basis of a flow diagram in FIG. 4. Firstly, a metered feeding of a first ingredient as free-flowing powdery ceramic material and of a second ingredient as additive takes place in step 100. Due to mixing of the first ingredient and of the second ingredient in the mixing system 22 in step 102, the first ingredient and the second ingredient become homogeneously mixed in the mixing system 22 as a mix enriched variably with the additive. Thereafter a further processing of the mix 34 as a ceramic starting substance takes place in step 104. In the process, the metered feeding in step 100 is performed by means of metering units 12, 14, wherein the metering units 12, 14 are controlled dynamically during the filling with respect to a throughput of the first ingredient or of the second ingredient. Furthermore, in step 100, the metering units 12, 14 are equipped at the outlet with the measuring units 16, 18, which monitor the quantity actually fed by the metering units 12, 14. After exiting from the mixing system 22, the mix can be fed in step 102 to the weighing scale 38. In the process, it is provided that the control unit 20 controls the metering units 12, 14 on the basis of the values of the weighing scale 38 and of the measuring units 16, 18.

The features in the foregoing and the features specified in the claims as well as the features that can be inferred from the figures may be advantageously implemented both individually and in various combinations. The invention is not limited to the described exemplary embodiments but can be modified in a number of ways within the know-how of the person skilled in the art.

### LIST OF REFERENCE SYMBOLS

2 Apparatus
4, 6 Filling funnel
8, 10 Inlet opening
12, 14 Metering unit
16, 18 Measuring unit
20 Control unit
22 Mixing system
24 Feeder
26 Springs
28 Holder
30 Mixing elements
32 Vibrator
34 Mix
36 Mold
38 Weighing scale
40 Semifinished product
42 Gradient
44 Curve
46 Curve
48 Component part
50 Curve
52 Curve
54 Curve
100 Step
102 Step
104 Step

1. An apparatus for mixing ingredients of a ceramic starting substance, wherein, via a first inlet opening, a free-flowing powdery ceramic material as a first ingredient and, via at least one further inlet opening, a free-flowing, powdery additive as a second ingredient can be fed respectively in metered manner to a mixing system, so that the first ingredient and the second ingredient become mixed homogeneously in the mixing system to form a mixture, which is enriched variably with the additive and can be fed as ceramic starting substance to a further processing.

2. The apparatus according to claim 1, in which the ceramic starting substance may be further processed to form a technical ceramic.

3. The apparatus according to claim 1, in which the ceramic starting substance may be further processed to a medical, especially a dental ceramic, wherein the first ingredient is preferably a ready-to-press granulate in the form of an RTP granulate of ZrO₂.

4. The apparatus according to claim 1, in which the first and/or the further ingredient can be fed in controlled manner to the mixing system via a metering unit.

5. The apparatus according to claim 4, in which the metering units can be controlled via a control unit during the feeding to the mixing system.

6. The apparatus according to claim 1, in which the metering unit is equipped with a measuring unit for monitoring the fed quantity.

7. The apparatus according to claim 6, in which the measuring unit is coupled with the control unit.

8. The apparatus according to claim 1, in which the mixing system is equipped with a downspout.

9. The apparatus according to claim 1, in which the mixing system is equipped with physical, static, or dynamic mixing elements, or generates an air swirl by means of air pressure or performs an air mixing combined with an air extraction process.

10. The apparatus according to claim 8, in which a mixing bar, a shaker plate, a sieve or an air-swirling system is provided on the downspout for mixing.

11. The apparatus according to claim 8, in which the downspout is climate-controlled and/or is equipped with a vibratory unit.

12. The apparatus according to claim 1, in which the mix can be fed to a weighing scale after exiting from the mixing system.

13. A method for mixing ingredients of a ceramic starting substance using the apparatus according to claim 1, in which the following steps are executed:
provision of a mixing system,
metered feeding of a first ingredient as a free-flowing powdery ceramic material and of a second ingredient as an additive,
mixing of the first ingredient and of the second ingredient in the mixing system, so that the first ingredient and the second ingredient become homogeneously mixed in the mixing system as a mix enriched variably with the additive, and
further processing of the mix as a ceramic starting substance.

14. The method according to claim 13, in which the metered feeding is performed by means of metering units, wherein the metering units are controlled dynamically during the filling with respect to a throughput of the first ingredient or of the second ingredient.

15. The method according to claim 13, in which the metering units are equipped at the outlet with measuring units, which monitor the quantity actually fed by the metering units.

16. The method according to claim 15, in which the control unit controls the metering units on the basis of the values of the weighing scale and of the measuring units.

17. The method according to claim 13, in which the mix is fed to a weighing scale after exiting from the mixing system.

18. The method according to claim 17, in which the control unit controls the metering units on the basis of the values of the weighing scale.
